(19) United States
(12) Patent Application Publication
(10) Pub. No.: US 2007/0055577 A1
(43) Pub. Date: Mar. 8, 2007

(54) Internet and wireless integrated virtual presence

(75) Inventor: Jason Ashton, Scotts Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CommonWealth Intellectual Property Holdings, Inc., Santa Cruz, CA (US)

(21) Appl. No.: 11/546,472

(22) Filed: Oct. 10, 2006

Related U.S. Application Data
(62) Division of application No. 09/863,124, filed on May 22, 2001, now abandoned.
(60) Provisional application No. 60/206,192, filed on May 22, 2000.

(51) Int. Cl. G06Q 30/00

(52) U.S. Cl. 705/26

(57) ABSTRACT

A server operating a website with discrete transactional webpages identifies subject matter for a sales contract between a merchant and an inquiring party. The website is provided with an augment logon procedure for potential inquiring parties, be they offerees or offerors to a contractual relationship. As part of the logon information of the inquiring party, at least one—a preferably a plurality—of direct contact routes from the server to the offeree and/or offeror is solicited. These direct contract routes can included landline, cell phone, pager, or other direct computer to computer communication. The inquiring party initially contacts the server and identifies the subject matter of the proposed contract, for example an airline trip, the sale of an electronics item such as a TV, or a restaurant reservation and at least one other parameter required for the consummation of a contract. This information is communicated to the merchant. The merchant either accepts or rejects the proposed contract parameter and communicates this fact to the server. The server then makes direct contact to the inquiring party with indexing occurring through the provided direct contract routes until actual contact is attained to the inquiring party. During the contract formation, direct server to inquiring party contact is repeated until an actual contact is established, enabling the virtual presence of the inquiring party for a sufficient interval to establish a contract.

### CROSS-REFERENCES TO RELATED APPLICATIONS

This application claims the benefit of U.S. Provisional application Ser. No. 60/206,192, filed May 22, 2000, the disclosure of which is incorporated by reference.

This invention relates to multiple to platform including the Internet, Wireless devices and Landlines. More particulary, a method of exchanging information and/or conducting transactions can maintained between parties from inception to enforceable contractual acceptance on multiple platforms; all the while maintaining a virtual presence during exchamges of information.

### BACKGROUND OF THE INVENTION

The Internet has enabled instant messaging, so-called on-line auctions and bidding processes. An item for Internet/Wireless on-line auction is posted on a webpage of a website identifying the subject matter for sale. In the usual case, posting of such merchandise for sale occurs against a clock. Inquiring parties who choose to visit the website may bid for desired items, as the clock runs down. Naturally, when the item approaches time-out of the clock, bidding intensifies. When the clock times-out, the highest bid is (usually) accepted.

Such (so-called on-line auction) bidding processes has included serious drawbacks. So-called on-line auctions can only have the bidders bidding against “the clock” rather than directly bidding against another bidder. For example, the fact that an inquiring party (after selecting an item now becomes the “bidder”) cannot be physically present in an electronic world, a so-called timed auction has been utilized as a substitute. Webster's New World Dictionary™ defines an auction as: “public sale of items to the highest bidder” rather than a sale to the last bidder; set to end at a predetermined time. In order for a true auction to take place, bidders must “bid against one another” not against a clock. Predetermined end of clock time-out bidding often defeats those who would have bid significantly more. In addition, a bidder making bids on multiple items can easily lose track of the pre-determined end of bidding time for each item. Thus, an auction is not achieved by definition, as the highest bidder did not acquire the desired item. Less than optimum results are achieved for both the selling parties and the buyers.

The Internet has also enabled product offerings which allow you to name your own price. Websites such as priceline.com™ and ebay™ enable bidding for items from airline tickets to used stereo equipment. Typically, after a buyer makes a bid for an item, they must continue to revisit the website for the status of the bid. Neither priceline.com™ nor ebay™ are capable of notifying the bidder as to the status of their bid. A pro-active query by the bidder must be pursued. So-called timed auctions which last for days require the arduous task of continuously revisiting the website. The log on procedures required to gain access to the internet, time required to navigate to the specific website, followed by further navigation of web pages to the location of status of bid makes this process extremely time consuming and inefficient.

In the case of the name your own price concept, where no other bidder is involved, the time elapsed to research the disposition of an offer, respond, inform and/or confirm the acceptance or rejection of an offer to inquiring parties via email makes this process less than optimum. The name your own price concept also requires the same arduous tasks by the “offeror;” accessing their internet account via time-consuming log on procedures, time required to navigate to the specific website hosting their email account, followed by further navigation of web pages containing their email account. Once again, notification is limited. Thus, the lack of notification or delay in awareness of notification will achieve less than optimum results for all parties involved. In either event, a “virtual presence” utilizing the “notification processes” is required for optimum results to the seller and buyer.

Instant messaging processes monitor the on-line status of designated users. Using current technology, as designated users log on and off the Internet, alerts are sent as to the status of those designated users on computer terminals. However, once a member logs off the Internet, instant messaging is disconnected. A “virtual presence” using the “notification process” can now allow indirect/direct contact with designated members of a user group who no longer are on line. For example, when members become mobile or a computer terminal is unavailable, instant messaging/communication can still be achieved using the “virtual presence notification processes.” For example, a member group using the “notification process” can be alerted when a fellow member activates their mobile phone, wireless device(s), pager, and/or other means of communication in addition to the traditional computer. The cost of communicating world wide is costly using traditional communication means such as the telephone, mobile phone, etc . . . making instant messaging a cost effective means of communicating. Using the “virtual presence notification process,” the cost effectiveness of instant messaging can now be achieved via contact routes and/or other net to phone and/or with voice recognition, transmit and receive messages around the world cost effectively using all other forms of communication devices. Thus, a “virtual presence” is maintained with all actively logged-on users from multiple platforms with communication means using numerous communication devices.

In what follows, we note a deficiency in all these prior art transactions. Specifically, there is no virtual presence to the merchant of either the offeree or the offeror (hereinafter the “inquiring party”) during the exchange of information and/or transactions. Thus, either the offeree or the offeror must take affirmative action to contact, respectively, the offeror or the offeree during the offers and counteroffers leading to contract formation. What is needed is a “virtual presence” via direct/indirect contact between parties on multiple platforms. This immediate and meaningful direct/indirect contact is what we now call “virtual presence notification process” during the exchange of information and/or transactions.

It will be realized that by making the above description, we identify the prior art in terms of a “short coming” or problem to be solved. In this disclosure, there follows the solution to the identified problem. Insofar as the prior art has failed to disclose the problems that we have just identified, we claim invention. It goes without saying that the identification of a problem to be solved—as well as the solution to the problem—can constitute invention.

### SUMMARY OF THE INVENTION

A notification process which allows a virtual presence to be maintained during the exchange of information and/or transactions across multiple platforms. The process automatically notifies the inquiring party and/or offeror as to the status of requested information and/or transaction(s) in real time. As part of the process, contact information of the inquiring party, at least one—preferably a plurality—of contact routes to the inquiring party/offeree and/or offeror is solicited. These contact routes can include landline, mobile phone, wireless devices, pager, computer-to-computer communication and/or other communication devices. The inquiring party initially identifies the subject matter of the proposed transaction and/or information requested, for example, an airline ticket, the sale of an electronic item such as a TV, a message to a member of a designated/un-designated user group, a hotel reservation and/or a restaurant reservation. This information may be communicated to another party. The responding party processes the information, and generates a response to the inquiring party. The response is sent to any or all of the inquiring party's contact routes. For example, when bidding on a desired item through an on-line auction site, the offeree can now notify the offeror that another party has placed a higher bid on the desired item. Thus, creating a virtual presence of the offeror at the on-line auction. The process may include continuous contact attempts until actual contact to the inquiring party is attained to assure the virtual presence of the inquiring party. During the process, inquiring party contact may be repeated until an actual contact is established, enabling the virtual presence of the inquiring party for a sufficient interval to provide information and/or a transaction. In addition, the “virtual presence notification process” will enable the removal of the time-out clock limitation of the so-called on-line auction. By being virtually present at the on-line auction bidding can continue until a stall in bidding has occurred. For example, an item up for bid is scheduled to time-out at 12:00 pm on Jan. 1, 1994. As long as bidding continues up to the pre-determined time driven end of bidding, the time for making bids is extended until a stall in bids occurs. Setting the “bidding stall time^{SM} ” at 15 minutes, a bid received at 11:50 am, Jan. 1, 1994, would automatically extend the end of bidding until 12:05 pm Jan. 1, 1994. Should another bid be received at 11:56 am Jan. 1, 1994 the end of bidding would automatically be extended to 12:11 pm, Jan. 1, 1994 and continue until no bids are received for 15 un-interrupted minutes. Thus, creating a virtual presence auction where items truly go to the highest bidder, rather than the last bidder, complete with the traditional “Going, going, gone!” functionality. Because a minimal amount of time may be required for bidding parties to respond to the notification process, a 15 minute auto extension will replace the traditional “Going, going, gone!” This time-out period may be extended or shortened accordingly.

Utility is set forth by providing a virtual presence using the notification process to deliver responses to parties across multiple platforms in a reasonable amount of time. Ending the need for so-called on-line timed auction to limit the auction process to items going to the last bidder versus the highest bidder. In addition, the virtual presence notification process can notify designated users that members of their group are available for communication via other communication devices across multiple platforms. Such as bidding for airline tickets, comparing and bidding on new and used electronic items (using the example of a TV), restaurant reservations, participating in online auctions, and notification to an inquiring party that a previously sold out hotel now has a cancellation and available room. The disclosed virtual presence enables the inquiring party to attend to the consummation of the transactions and/or contracts and/or exchanges of information on an as needed basis assuring real time and contract closure with minimal distraction from normal daily routines.

### BRIEF DESCRIPTION OF THE DRAWINGS

FIG. 1 is a diagrammatic representation of an inquiring wireless device making server connection with geographic location being reported together with direct contact information being stored in a data base for enabling virtual presence between the inquiring device and a plurality of commercial establishments for contract establishment by price comparison augment with virtual inquiring party presence for Internet sales contract formation; and,

FIG. 2 is a diagram of a purchase or Internet sales contract formation transaction where geographic location of the inquiring party can be ignored.

### DESCRIPTION OF THE SPECIFIC EMBODIMENTS

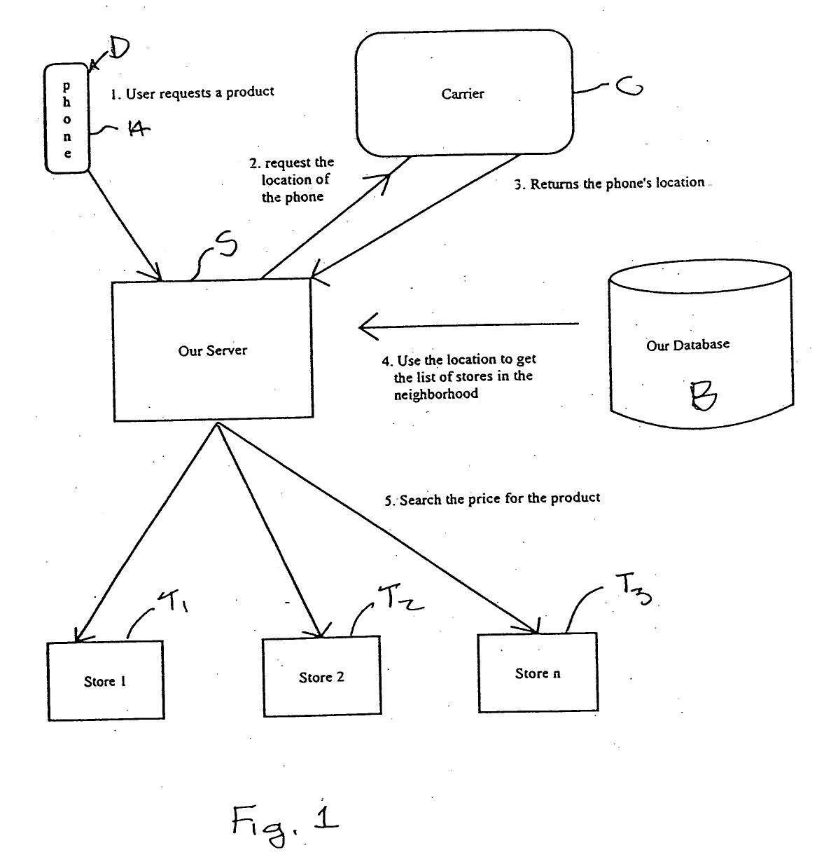

Referring to FIG. 1, inquiring device D is shown in the form of cellular Internet connected phone 14. It will be understood that this device can occupy a number of differing formats. For example, it can be wireless connected laptop, an Internet connected computer, a pager having response characteristics, or a wireless personal digital assistant. Virtually any kind of Internet connected device will suffice.

I prefer a wireless Internet connected device. This preference comes from the immediacy of response that such devices can add to the virtual presence required by this disclosure.

It will be further understood, that such wireless devices now automatically provide geographical information. For example, it will soon be required that all mobile phones have the capability of informing those called of their geographic location. Furthermore, it is now common to combine such wireless devices with GPS processes. For example, many new cars come equipped with mobile cell phone responding devices which are capable of outputting to a control center the geographic location at the time of call.

Initial connection is made to the server S supplying the selling service. Diversion is then made to carrier C for determining geographic location. This information is transmitted back to server S.

Server S maintains database B. Utilizing the geographical information from carrier C, respective stores T1, T2 and/or T3 are designated. The reader should understand that the number of respective stores T designated is only exemplary. Further, stores T can include restaurants, bicycle shops, car dealers, and virtually any kind of merchant having contact with server S.

Each of the respective stores T will usually have their own website and associated webpages. However, the reader should understand that this is not absolutely required. What is required is prompt response to server S.

Device D is provided with what I call an augmented logon. Specifically, the logon requires the identification of the goods or services (i.e. subject matter) of the contractual relationship and an address of a device where direct an immediate contact may be had with the operator of the inquiring device. During this session, the inquiring device would enter the address (here a mobile phone number) where immediate contact can be made. By way of an example, when away from his hardwired computer, the inquiring device may well be a wireless Internet connected personal digital assistant.

Using the example of FIG. 1, three respective types of transactions can be discussed. These can include the making a restaurant reservation (which for the purpose of this disclosure will be considered “a contract”), the purchase of an electronic item (large scale TV), and finally a classical auction of either of these respective two items.

First, the hotel situation. Let us presume that inquiring device D has made it known over the Internet that he desires a room at a specific hotel. Either from or through server S he is supplied with ratings and locations of respective hotel in the desired area (hotels) T1, T2 and/or T3 together with various ratings—either as to quality the star rating or alternatively price range.

Equipped with this information, the operator of inquiring device D then forwards a request for the service (i.e. a four star hotel). Thus it will be seen that the subject matter of the contract—a four star hotel—and at least one additional parameter—ocean view is being forwarded to the hotel. Having made a request on a convenient geographic basis, the operator of inquiring device D proceeds about other business.

Server S then contacts the selected hotel, say store T3. The hotel data base either accepts or rejects the contract for the room. This information is communicated back to server S. Presuming the reply from the hotel is to inform the operator of device that the hotel is sold out for the date requirement set by the operator of device D. The hotel can notify the operator of device D using the virtual presence notification processes if the previously sold out hotel now has a cancellation making a room available to the operator of device D. The virtual presence notification process will automatically contact the operator of device D that a room is now available. The operator of device D can now consummate the contract within the context of this disclosure. Alternatively, the reply could require affirmative acceptance by inquiring device D so that the reservation is “confirmed” to the satisfaction of the hotel. Other variations in the contract can occur.

Finally, let us consider the case of an auction, with store T1 serving as the so-called auction site. In this example I will consider the preowned large screen TV as being the subject matter of the auction. This time, a plurality of inquiring devices D are present with all such inquiring devices D submitting bids. With respect to each bid, server S through wireless Internet connected phone 14 replies Through instant interaction, the operator of each inquiring device D will be informed of bid status—low, high, or accepted. Particularly, notification is automatically transmitted to device D across multiple platforms to one or all contact routes if a higher bid is placed on the item by another party. Thus, allowing the operator of device D whose bid was defeated to place a higher bid should operator choose to continue bidding. Further, the vagaries of so-called on-line auction interjection of clocks timing bids are completely avoided. Further, from the standpoint of the auctioneer, status of the auction can be simultaneously broadcast to each inquiring device D, including all communication devices and/or wireless Internet connected phones 14. For example, the notification process sends the last highest bid notification should their bid be defeated. All bidders participating in the auction for the same item can continue to bid until a stall in bidding occurs. Creating a virtual presence auction extending pre-determined end of bidding allowing that specific item to go to the highest bidder rather than the last bidder.

With respect to auctions, a further notation can be made. Where relatively expensive items are at auction, prudent auctioneers seek confirmation of the auction contract. Utilizing the “virtual presence” described from the online connection utilized here, such confirmation can be required of inquiring device D. Lacking such confirmation, alternative sale can occur with the bidding audience still in “virtual attendance.”

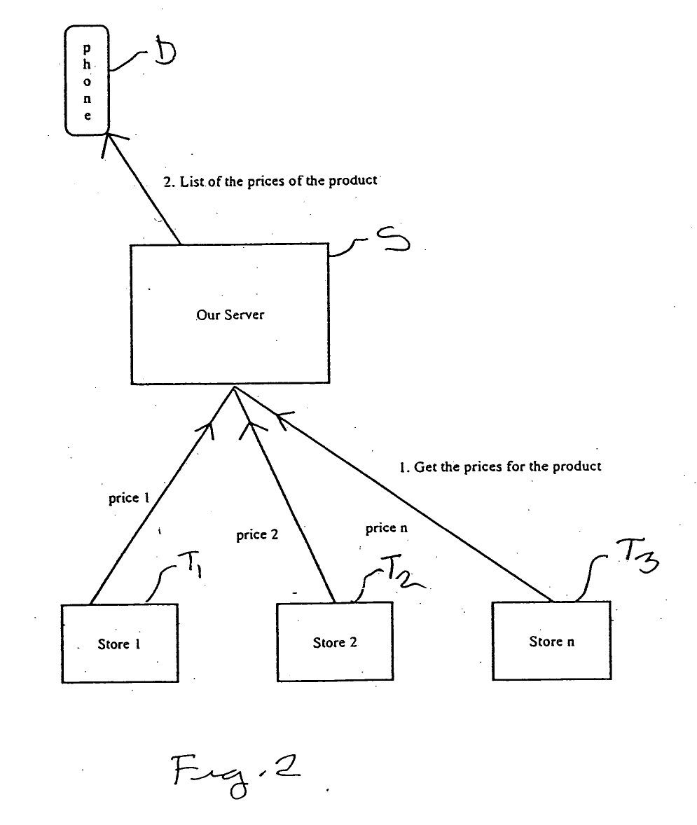

Referring to FIG. 2, the simple case of the auction of an airline ticket (seat) to a given destination can be considered. Presume that inquiring device D through cellular Internet connected phone 14 has requested information on an airplane ticket from San Francisco to New York. Each of the airlines or (stores) T1, T2 and/or T3 has replied, with respective airline T1 giving the lowest fare. This fare, however, is still to high for the operator of inquiring device D. At this point, the operator of inquiring device D bids $400 for the trip. Server S immediately communicates this to airline T1 where the counter offer is accepted or rejected. Presuming that the airline T1 would rather have a full plane than an empty seat, the interests of both sides are preserved.

The reader should understand that interruption of the contractual process is presumed. For example, bidding for airline trips can be several days apart—all for the same trip. Server S has the compatibility of remembering past unsuccessful transactions and resuming communication where communication was left off. Other variations can be made. Let us further consider FIG. 1 in the sale of an electronic item such as a large screen TV. Further, let us consider the simultaneous solicitation of both a direct sale and an auction for a used large screen TV. It will be seen that the disclosed process closely interacts with both inquiring and responding parties' processes.

Again, inquiring device D contacts server S—which in this case happens to be the server of a so-called on-line auction service. Using multiple platforms including wireless Internet connected phone 14 through a menu driven Internet connection, a 54″ large screen TV manufactured by the Sony Corporation of Tokyo, Japan is selected. Further, and due to the desire of the operator of inquiring device D to bid—to provide installation and service the respective response bids are generated to stores T1, T2 and/or T3. This time, quotes for new 54 inch Sony TVs are returned. At the same time, the operator of at least one of the stores T—or perhaps the operator of server S—chooses to make known to inquiring device D that an equivalent one year old used large screen TV is available. It should be noted, that in this case the replying merchant may choose to reply with screens within ranges spaced originally around the size of the specified 54 inch wide screen TV. Reply to the inquiry of inquiring device D at cellular Internet connected phone 14 thus occurs—two merchants quoting new merchandise and the third merchant setting forth both new and used (pre-owned) merchandise.

Upon receiving reply at inquiring device D, the operator may note small price deviation and may choose to reply to store T3 with a counter-offer or bid. For example, the bid could be directed to the preowned TV. Presuming acceptance of the counter offer for the preowned TV at a lower price than originally posted, the reader will understand that the operator of inquiring device D through cellular Internet connected phone 14 has become the offeror and that the merchant owning store T3 is now the offeree who is in the legal position of forming the contract through acceptance.

1-38. (canceled)

39. A method of managing bidding in a computer-facilitated auction, the method comprising:
determining a first ending time for ending bidding in the computer-facilitated auction;
determining a first time period by which the first ending time of the computer-facilitated auction will be extended upon receipt of a bid within a second time prior to the first ending time;
receiving a bid within the second time period; and
in response to receiving the bid within the second time period, extending the first ending time by the first time period; and
ending the computer-facilitated auction after the first ending time when no bids have been received for a time period equal to at least the first time period.

40. The method of claim 39 further including:
after the first ending time, receiving another bid; and
again extending the time for ending bidding.

41. The method of claim 39 wherein ending the computer-facilitated auction occurs when no bids have been received for a time equal to at least the first time period and the first ending time has passed.

42. The method of claim 39 further comprising notifying at least one bidder of the bid received within the second time period.

43. The method of claim 42 further comprising notifying all bidders of the bid received within the second time period.

44. The method of claim 42 further in which the step of notifying at least one bidder comprises sending a notification via a plurality of different communication channels.

45. The method of claim 44 wherein the step of sending a notification includes sending the notification through a wireless network to a receiving device, the receiving device being configured to enable the at least one bidder to make another bid.

46. The method of claim 44 wherein the communication channels comprise at least one of a wireless network coupled to a mobile telephone, an internet connected phone and a wireless personal digital assistant.

47. The method of claim 39 further including notifying a plurality of bidders of the step of extending the first ending time by using a computing network.

48. The method of claim 47 wherein the computing network uses instant messaging to notify the plurality of bidders.

49. A computing system configured for managing an auction, the computing system comprising:
means for determining a first ending time for ending bidding in the computer-facilitated auction;
means for determining a first time period by which the first ending time of the computer-facilitated auction will be extended upon receipt of a bid within a second time prior to the first ending time;
means for receiving a bid within the second time period; and
means in response to receiving the bid within the second time period, for extending the first ending time by the first time period; and
means for ending the computer-facilitated auction after the first ending time when no bids have been received for a time equal to at least the first time period.
